(19) United States
(12) Patent Application Publication
(10) Pub. No.: US 2003/0037195 A1
(43) Pub. Date: Feb. 20, 2003

(54) On-board input/output port

(76) Inventor: James Cheng, Baldwin Park, CA (US)

Correspondence Address: JOE NIEH, 17800 CASTLETON STREET, SUITE 475, CITY OF INDUSTRY, CA, 91748, US

(21) Appl. No.: 09/929,755

(22) Filed: Aug. 14, 2001

(51) Int. Cl. G06F 13/00

(52) U.S. Cl. 710/300

(57) ABSTRACT

An on-board input/output port attached to and electrically connected to a single board computer. An add-on card can be inserted into the on-board input/output port to extend or enhance the single board computer's performance and capabilities.

### BACKGROUND

1. Field of Invention

The present invention relates to a single board computer on-board input/output port wherein an add-on card can be inserted into the on-board input/output port to extend or enhance the single board computer's performance or capabilities.

2. Description of Related Art

Modem personal computers may be generally divided into two types. The most common type of modem personal computers used by the consumers is built on a motherboard. The central processing unit, memory chips, input/output chip, and the various buses are built on the motherboard. On some motherboards, a built-in chip for sound and another built-in chip for video are also included on the motherboard. Various other components and peripherals, such as the hard drive, floppy drive, CD-ROM drive, video card, monitor, keyboard, mouse, sound card, speakers, modem, printer, and scanner are then connected to the motherboard either with a cable or through an add-on card that is inserted into one of the ports on the motherboard. The modem motherboard generally has PCI ports, ISA ports, and an AGP port. The ISA ports are being replaced by PCI ports, which is the most common port. The AGP port is a specialized port designed for video. The monitor is connected to an AGP video card that is inserted in the AGP port. The AGP port is a much faster port than the traditional video port.

The other type of modem personal computer is built as a single board computer that is inserted into slots on a backplane. This type of personal computer is most commonly used in the industrial environment. The single board computer's function is equivalent to a motherboard. The central processing unit, memory chips, input/output chip, and the various buses are built on the single board computer. On some single board computers, a built-in chip for sound and another built-in chip for video are also included on the single board computer. The single board computer itself does not have any ports or slots for insertion of additional cards. The single board computer is inserted into slots on a backplane. The backplane has various PCI and ISA slots for attaching and connecting the single board computer and various other cards to components and peripherals, such as the hard drive, floppy drive, CD-ROM drive, monitor, keyboard, mouse, speakers, modem, printer, and scanner. Due to technical difficulties in terms of noise and stability, an AGP port is not used for single board computers. Generally a slower PCI card inserted into a PCI slot is used for video connection for single board computers. AGP ports are also not available on any of the currently available backplanes.

### SUMMARY OF THE INVENTION

The present invention is an on-board input/output port on a single board computer. An add-on card can be inserted into the on-board input/output port to extend or enhance the single board computer's performance and capabilities.

### BRIEF DESCRIPTION OF THE DRAWINGS

FIG. 1 shows the front view of the single board computer with an add-on card inserted in the on-board input/output port on front side of the single board computer.

FIG. 2 shows the top view of the single board computer inserted on the backplane with an add-on card inserted in the on-board input/output port on the front side of the single board computer.

FIG. 3 shows the side view of the single board computer inserted on the backplane with an add-on card inserted in the on-board input/output port on the front side of the single board computer.

FIG. 4 shows the rear view of the single board computer with an add-on card inserted in the on-board input/output port on the backside of the single board computer.

FIG. 5 shows the top view of the single board computer inserted on the backplane with an add-on card inserted in the on-board input/output port on the backside of the single board computer.

FIG. 6 shows the side view of the single board computer inserted on the backplane with an add-on card inserted in the on-board input/output port on the backside of the single board computer.

### DETAILED DESCRIPTION OF THE PREFERRED EMBODIMENT

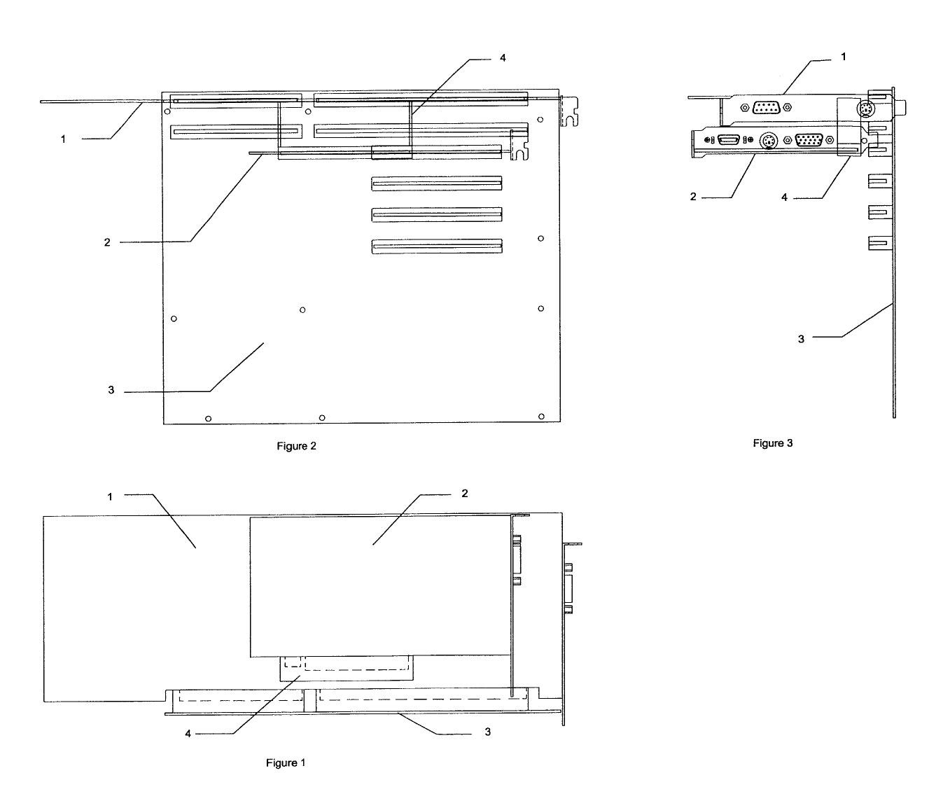

The preferred embodiment of the present invention is shown in FIG. 1. A single board computer 1 has a front side and a back side. The front side is the side where most if not all of the chips and components are placed. The back side is the side where the soldering of the chips and component to the board are located.

The preferred embodiment comprises of a single board computer 1, with a right angle on-board input/output port 4 rigidly attached to the front of the single board computer 1 and electrically connected to the input-output circuitry on the single board computer 1, inserted in a slot on a backplane 3 and an add-on card 2 inserted parallel to the single board computer 1 in the right angle on-board input/output port 4. The ports on the add-on card 2 may be extended to a plate or panel next to the ports on the single board computer 1 with a cable such that all the ports are on the same plane as the single board computer 1. In the preferred embodiment of the present invention, the add-on card 2 is an AGP video card that is commercially available at most electronic and computer stores.

FIG. 2 is the top view of the single board computer 1, with a right angle on-board input/output port 4 rigidly attached to the front of the single board computer 1 and electrically connected to the input-output circuitry on the single board computer 1, inserted in a slot on a backplane 3 and an add-on card 2 inserted parallel to the single board computer 1 in the right angle on-board input/output port 4.

FIG. 3 is the side view of the single board computer 1, with a right angle on-board input/output port 4 rigidly attached to the front of the single board computer 1 and electrically connected to the input-output circuitry on the single board computer 1, inserted in a slot on a backplane 3 and an add-on card 2 inserted parallel to the single board computer 1 in the right angle on-board input/output port 4. The ports on the add-on card 2 may be accessed from the same direction as the ports on the single board computer 1.

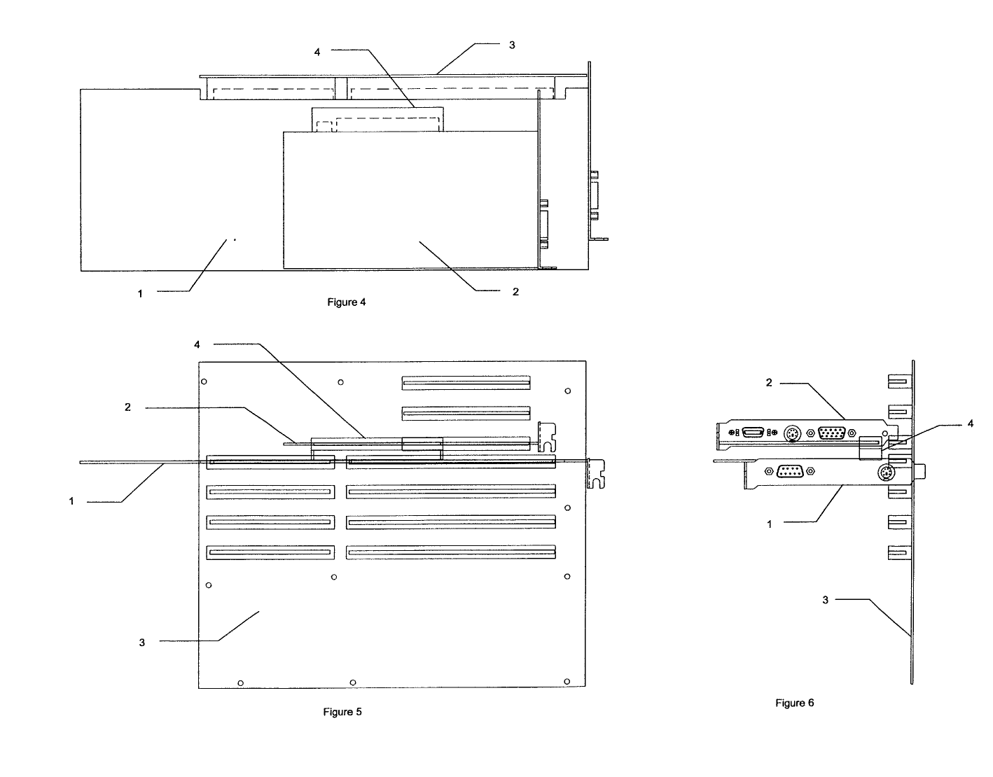

Another embodiment of the present invention is shown in FIG. 4. The embodiment comprises of a single board computer 1, with a right angle on-board input/output port 4 rigidly attached to the back of the single board computer 1 and electrically connected to the input-output circuitry on the single board computer 1, inserted in a slot on a backplane 3 and an add-on card 2 inserted parallel to the single board computer 1 in the right angle on-board input/output port 4. The ports on the add-on card 2 may be extended to a plate or panel next to the ports on the single board computer 1 with a cable such that all the ports are on the same plane as the single board computer 1. In the preferred embodiment of the present invention, the add-on card 2 is an AGP video card that is commercially available at most electronic and computer stores.

FIG. 5 is the top view of the single board computer 1, with a right angle on-board input/output port 4 rigidly attached to the back of the single board computer 1 and electrically connected to the input-output circuitry on the single board computer 1, inserted in a slot on a backplane 3 and an add-on card 2 inserted parallel to the single board computer 1 in the right angle on-board input/output port 4.

FIG. 6 is the side view of the single board computer 1, with a right angle on-board input/output port 4 rigidly attached to the back of the single board computer 1 and electrically connected to the input-output circuitry on the single board computer 1, inserted in a slot on a backplane 3 and an add-on card 2 inserted parallel to the single board computer 1 in the right angle on-board input/output port 4. The ports on the add-on card 2 may be accessed from the same direction as the ports on the single board computer 1.

Another embodiment of the present invention has two supporting posts with one supporting post under each end of the right angle on-board input/output port 4. One end of the supporting post will support the bottom of the right angle on-board input/output port 4 and the other end of the supporting post will rest on the backplane 3. The supporting posts will provide support to the right angle on-board input/output port 4 when force is exerted on the right angle on-board input/output port 4 while inserting the add-on card 2.

In the preferred embodiment of the present invention, the single board computer 1 may have a video processing chip that is override by the inserted AGP video card. The advantage of an AGP video card is that it has a much faster processing speed and capacity than any video processing chip on the single board computer 1 and also faster than any PCI video cards. A further advantage of the present invention is that any commercially available AGP video card may be selected to be inserted in the on-board input/output port 4. Another advantage of the present invention is that the AGP video card may be easily replaced or upgraded when the need arises, whereas, if a video chip on the single board computer 1 needs replacing or upgrading, the entire single board computer 1 must be replaced.

What is claimed is:

1. An on-board input/output port comprising:
an input/output port attached to and electrically connected to a single board computer wherein an add-on card can be inserted in the input/output port to extend or enhance the single board computer's performance and capabilities.

2. An on-board input/output port according to claim 1, wherein said input/output port is rigidly attached to the front side of the single board computer.

3. An on-board input/output port according to claim 1, wherein said input/output port is rigidly attached to the backside of the single board computer.

4. An on-board input/output port according to claims 2 or 3, wherein said input/output port is supported by multiple posts under the input/output port.

5. An on-board input/output port according to claim 2 or 3, wherein said input/output port is parallel to the plane of the single board computer.

6. An on-board input/output port according to claim 1, wherein said input/output port is an AGP port.

7. An on-board input/output port according to claim 2, wherein said input/output port is an AGP port.

8. An on-board input/output port according to claim 3, wherein said input/output port is an AGP port.

9. An on-board input/output port according to claim 5, wherein said input/output port is an AGP port.

10. An on-board input/output port comprising:
an input/output port rigidly attached to a single board computer near the contact pins at the bottom of the single board computer and electrically connected to the single board computer wherein an add-on card can be inserted in the input/output port to extend or enhance the single board computer's performance and capabilities.

11. An on-board input/output port according to claim 10, wherein said input/output port is rigidly attached to the front side of the single board computer.

12. An on-board input/output port according to claim 10, wherein said input/output port is rigidly attached to the backside of the single board computer.

13. An on-board input/output port according to claims 11 or 12, wherein said input/output port is supported by multiple posts under the input/output port.

14. An on-board input/output port according to claim 10, wherein said input/output port is an AGP port.

15. An on-board input/output port according to claim 11 or 12, wherein said input/output port is parallel to the plane of the single board computer.

16. An on-board input/output port according to claim 11, wherein said input/output port is an AGP port.

17. An on-board input/output port according to claim 12, wherein said input/output port is an AGP port.

18. An on-board input/output port according to claim 15, wherein said input/output port is an AGP port.
